(19) United States
(12) Patent Application Publication
(10) Pub. No.: US 2018/0084326 A1
(43) Pub. Date: Mar. 22, 2018

(54) HEADPHONE DEVICE

(71) Applicant: Leigh M. Rothschild, Miami, FL (US)

(72) Inventor: Leigh M. Rothschild, Miami, FL (US)

(21) Appl. No.: 15/707,410

(22) Filed: Sep. 18, 2017

Related U.S. Application Data
(60) Provisional application No. 62/397,982, filed on Sep. 22, 2016.

(51) Int. Cl. H04R 1/10; H04R 5/033

(52) U.S. Cl. CPC H04R 1/1008; H04R 1/105; H04R 1/1066; H04R 1/1083; H04R 5/033; H04R 2420/07; H04R 1/1041

(57) ABSTRACT

A headphone device is disclosed. The headphone device comprises a right side sound emitter and a left side sound emitter connected with extreme ends of a headphone band. The right side sound emitter and the left side sound emitter are ear cups. The headphone band is made of a flexible material. The headphone device comprises one or more auxiliary sound emitters present either adjacent to the extreme ends of the headphone band or on an upper section of the right side sound emitter and the left side sound emitter. The one or more auxiliary sound emitters are directed towards ears of the user. The headphone device further comprises a wireless control circuit for receiving audio data wirelessly from an audio device. The headphone device comprises a power source for powering the wireless control circuit, the right side sound emitter, the left side sound emitter, and the one or more auxiliary sound emitters. The headphone device comprises audio control keys for controlling volumes of the right side sound emitter, the left side sound emitter, and the one or more auxiliary sound emitters. The headphone device may either be used in an overhead configuration or in an over the ears configuration.

### CROSS REFERENCE TO RELATED APPLICATIONS

This application claims the benefit of U.S. Provisional Application No. 62/397,982, filed Sep. 22, 2016, which is incorporated by reference in its entirety.

### FIELD OF THE DISCLOSURE

The present disclosure is generally related to headphones and more particularly to over the ear headphones.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Audio devices such as a Sony Walkman®, iPod Shuffle®, iPod Nano®, and iPod Touch® are used by millions of users, for listening to music. The audio devices are generally connected to headphones for transferring sound to the user's ears. Headphones provide a private experience to a user. Conventional headphones are available as in the ear configuration and over the ear configuration.

Usage of in the ear headphones provides a pure acoustic experience of audio, as they fit into ear canal of a user. Further, usage of in the ear headphones also has drawbacks associated to them. While a user has put on in the ear headphones and listening to an audio, the user will not be able to hear any external sound. The external sound may include a person calling the user, or a distress sound such as a fire alarm, siren from an ambulance, police, and fire brigade vehicles.

Over the ear headphones are bigger in size and covers entire ear auricle of a user. Over the ear headphones press the ear auricle to fit tightly and to prevent loss of audio. Extended usage of over the ear headphone results in ear ache and sweating around the ears. Thus, the user often needs to remove on the ear headphones, after a certain time has lapsed.

Further, a user also poses difficulty in wearing in the ear headphones and over the ear headphones while the user performs any movement. An audio cable hanging from the headphones often obstructs in movement, repeatedly disconnects from audio device, and plugs out of the ears. For example, the user faces difficulty in wearing the headphones while walking and exercising.

Thus, a headphone that could provide a sense of comfort and could be used by a user for prolonged hours is much desired.

### BRIEF SUMMARY

It will be understood that this disclosure in not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

In an example embodiment, a wireless headphone device is provided. The wireless headphone device comprises a right side sound emitter and a left side sound emitter connected with extreme ends of a headphone band. The right side sound emitter and the left side sound emitter are ear cups. The headphone band is made of a flexible material. The headphone device further comprises one or more auxiliary sound emitters present either adjacent to the extreme ends of the headphone band or on an upper section of the right side sound emitter and the left side sound emitter. The one or more auxiliary sound emitters are directed towards ears of the user. The wireless headphone device further comprises a wireless control circuit for receiving audio data wirelessly from an audio device. The wireless headphone device further comprises a power source for powering the wireless control circuit, the right side sound emitter, the left side sound emitter, and the one or more auxiliary sound emitters. The wireless headphone device further comprises audio control keys for controlling volumes of the right side sound emitter, the left side sound emitter, and the one or more auxiliary sound emitters.

In another example embodiment, a wired headphone device is provided. The wired headphone device comprises a right side sound emitter and a left side sound emitter connected with extreme ends of a headphone band. The right side sound emitter and the left side sound emitter are ear cups. The headphone band is made of a flexible material. The wired headphone device further comprises one or more auxiliary sound emitters present either adjacent to the extreme ends of the headphone band or on an upper section of the right side sound emitter and the left side sound emitter. The one or more auxiliary sound emitters are directed towards ears of the user. The wired headphone device further comprises a pair of wires connected to the right side sound emitter and the left side sound emitter. The pair of wires transfers audio from an audio device to the right side sound emitter, the left side sound emitter, and the one or more auxiliary sound emitters.

In another example embodiment, a method of using a headphone device is provided. The method comprises wearing a headphone by a user in either an overhead configuration or in around a neck configuration. During the overhead configuration a headphone band resides over head of the user and a right side sound emitter. A left side sound emitter of the headphone, present as ear cups, covers respective ears of the user. During around the neck configuration, the headphone band lie around the neck of the user. The right side sound emitter and the left side sound emitter either partially cover ears of the user or lie exactly below the ears of the user. One or more auxiliary sound emitters present each on a right side and a left side of the headphone are directed towards respective ears of the user.

Other systems, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a block diagram of a headphone device 100, according to an embodiment of the current disclosure.

FIG. 2A illustrates the headphone device 200 being worn by a user in an overhead configuration, according to an embodiment of the current disclosure.

FIG. 2B illustrates a top view of the headphone device 200, according to an embodiment of the current disclosure.

FIG. 3 illustrates a headphone device 300 being worn by a user in around the neck configuration, according to another embodiment of the current disclosure.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Some embodiments of this invention, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present invention, the preferred, systems and methods are now described.

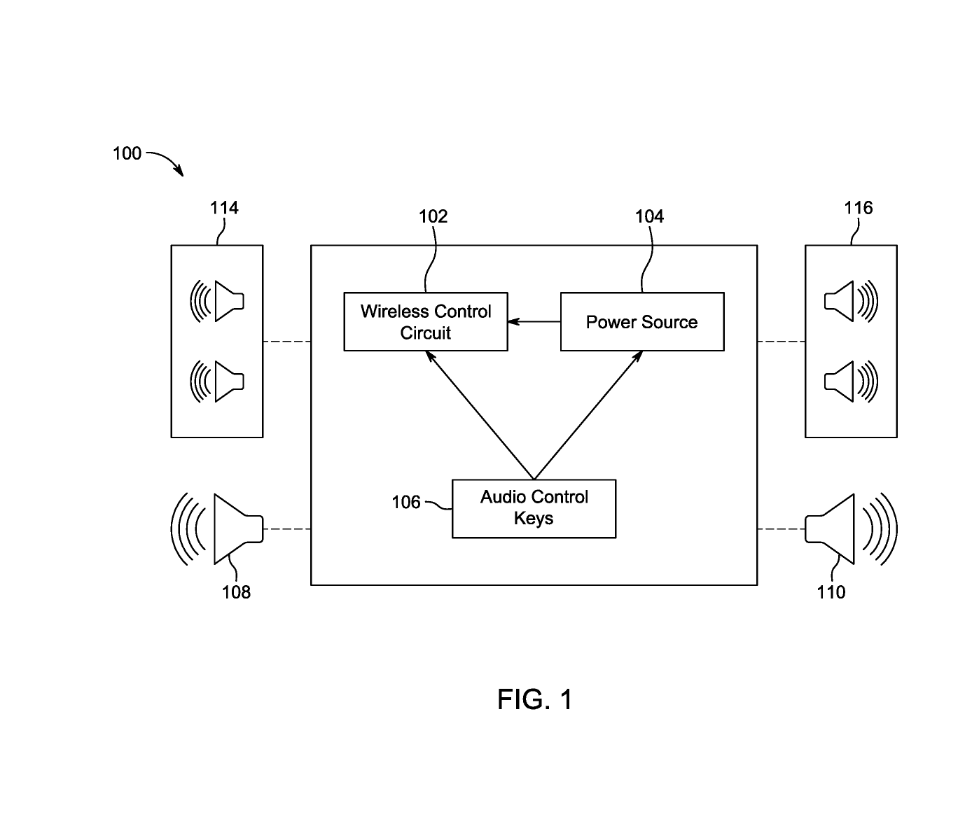

FIG. 1 illustrates a block diagram of a wireless headphone device 100 in accordance with an embodiment of current disclosure. The headphone device 100 may comprise a right side sound emitter 108 and a left side sound emitter 110. The right side sound emitter 108 and the left side sound emitter 110 may be connected with extreme ends of a headphone band 212 (Shown in FIG. #2) Further, the right side sound emitter 108 and the left side sound emitter 110 may be present as ear cups. The headphone band 212 may be made of a flexible material like plastic or any other material currently used in over the ear headphones and known in the art.

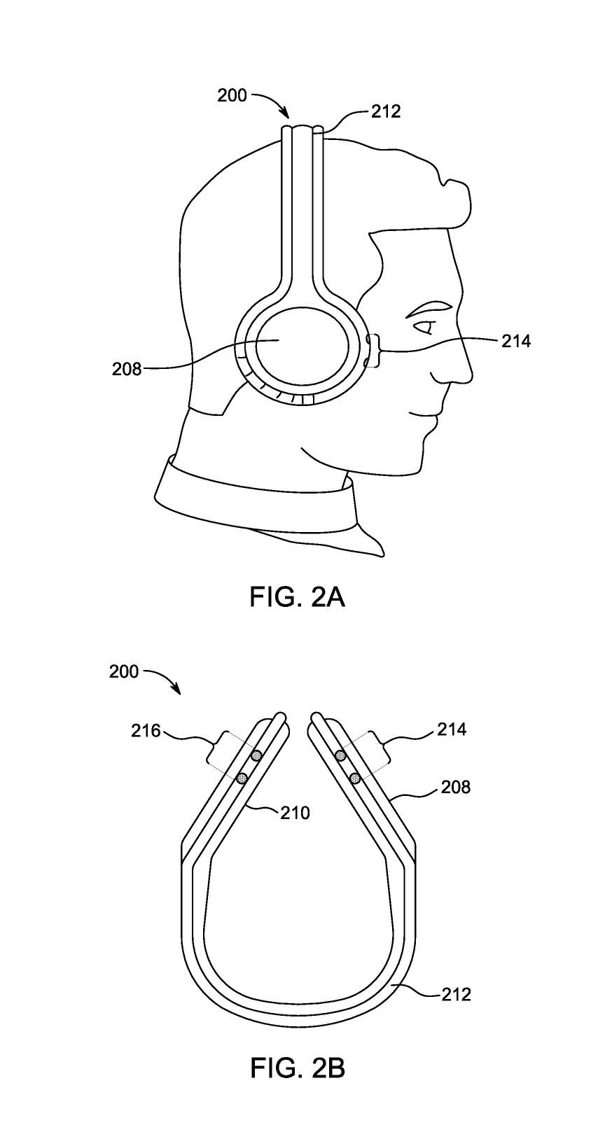

In one embodiment, the headphone device 100 may be worn by the user in an overhead configuration, as shown in FIG. 2A. The headphone band 212 may rest over head of the user. The right side sound emitter 208 and the left side sound emitter 210 may be placed over respective ears of the user, to cover them completely and to provide isolation from any external noise. In one case, noise cancellation technique may be used in the headphone device 200 to provide sound free of any external noise.

The headphone device 100 may comprise one or more auxiliary sound emitters 114 and 116. A number of the one or more auxiliary sound emitters 114 and 116 may vary from two to many. FIGS. 1, 2A, 2B, and 3 are illustrated to include two sound emitters 114 and 116, as exemplary embodiments. The number of the one or more auxiliary sound emitters 114 and 116 may be varied to suit requirement of a user using the headphone device 100 in different environments.

In one embodiment, the one or more auxiliary sound emitters 114 and 116 may be present on a right side of the right side sound emitter 208 and a left side of the left side sound emitter 210. The one or more auxiliary sound emitters 114 and 116 may be present as a pair of right side auxiliary sound emitters 214 present on the right side of the right side sound emitter 208 and a pair of left side auxiliary sound emitters 216 present on left side of the left side sound emitter 210. Above described positioning of the auxiliary sound emitters is shown in FIG. 2A and FIG. 2B, where the FIG. 2B illustrates a top view of the headphone device 200.

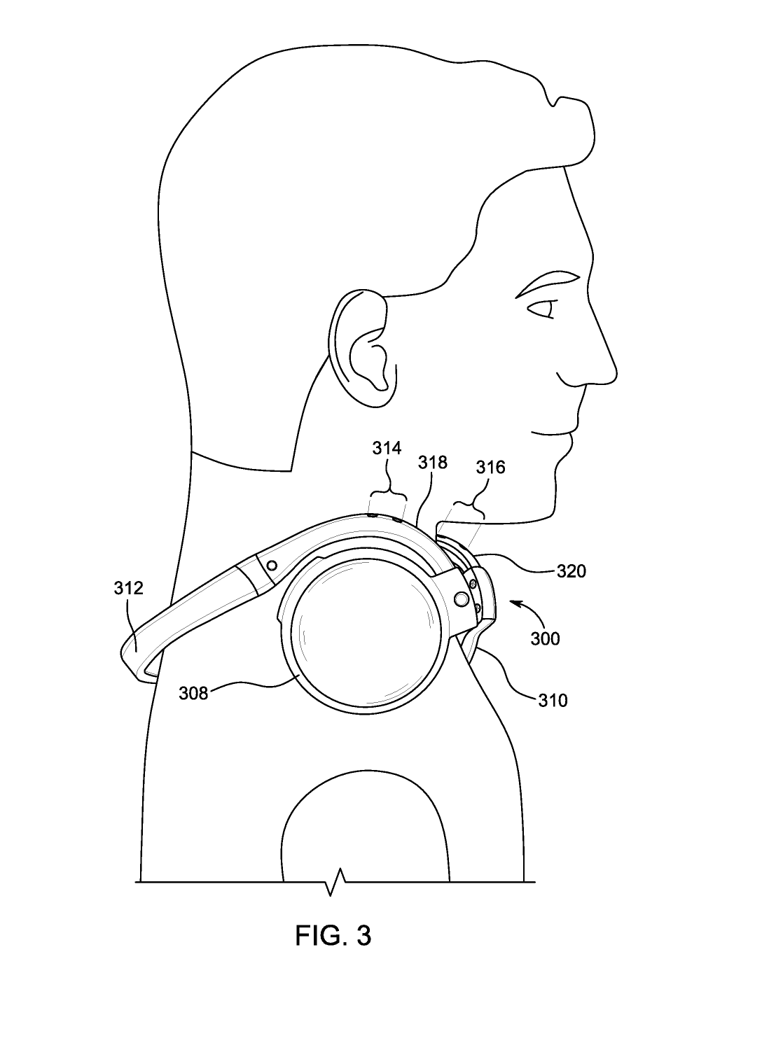

In another embodiment, the one or more auxiliary sound emitters may be present adjacent to the extreme ends of the headphone band 312, as shown in the headphone device 300 of FIG. 3. The one or more auxiliary sound emitters may be present as a pair of right side auxiliary sound emitters 314 present adjacent to a right side extreme end 318 and a pair of left side auxiliary sound emitters 316 present adjacent to a left side extreme end 320 of the headphone band 312.

In one case, the user may wear the headphone device 300 in an around the neck configuration. In around the neck configuration, the headphone band 312 may lie around the neck of the user. The right side sound emitter 308 and the left side sound emitter 310 may be used either to partially cover the ears or to keep the ears open. In order to keep the ears open, the right side sound emitter 308 and the left side sound emitter 310 may lie below the respective ears.

In one embodiment, while the headphone device 300 is used in around the neck configuration, the one or more auxiliary sound emitters 314 and 346 may be directed towards ears of the user. During such usage, the right side auxiliary sound emitters 314 may transmit the sound in a direction of a right ear. The left side auxiliary sound emitters 316 may transmit the sound in a direction of a left ear. But, the audio received from the right side sound emitter 308 and the left side sound emitter 310 may not be loud enough because the right side sound emitter 308 and the left side sound emitter 310 do not overlap the ear.

In one embodiment, the headphone device 300 may comprise audio amplifiers. The audio amplifiers may boost volumes of at least one of the right side sound emitter 308, the left side sound emitter 310, the right side sound emitter 308, and the left side sound emitter 310. The audio amplifiers may either be present on the headphone device 100 or the audio device. Thus, using the headphone device 300 in around the neck configuration along with amplified audio may help the user to hear external sound along with the audio of the headphone device 300. The external sound may be a distress sound or someone calling the user, etc

In one embodiment, the right side sound emitter 308 and the left side sound emitter 310 may play different channels of the audio data. Playing different channels of the audio data by different sound emitters may provide the user with a multi-channel music experience. Further, the right side auxiliary sound emitters 314 and the left side auxiliary sound emitters 316 may contribute in providing a nearly 3-Dimensional surround sound experience by using multi-channel properties of the audio data.

In one embodiment, the headphone device 100 may be a wireless headphone and may comprise a wireless control circuit 102 for receiving audio data wirelessly from an audio device. Further, the headphone device 100 may also comprise a power source 104. The power source 104 may be used to power the wireless control circuit 102, the right side sound emitter 108, the left side sound emitter 110, and the one or more auxiliary sound emitters (the right side auxiliary sound emitters 214 and the left side auxiliary sound emitters 216). The headphone device 100 may use button cells or rechargeable pencil cells or solar cells as the power source 104.

In one embodiment, the headphone device 100 may comprise audio control keys 106. The audio control keys 106 may control a play/pause function. The audio control keys 106 may either be soft keys or touch buttons present on at least one of the right side sound emitter 108, the left side sound emitter 110, and the headphone band 212. In one case, the audio control keys 106 may be present over a user interface of the audio device as soft keys.

In one embodiment, the headphone device 100 may be a wired headphone. The headphone device 100 may comprise a pair of wires. The pair of wires may be connected to the right side sound emitter 108 and the left side sound emitter 110. The pair of wires may transfer audio from an audio device to the right side sound emitter 108, the left side sound emitter 110, and the one or more auxiliary sound emitters (the right side auxiliary sound emitters 114 and the left side auxiliary sound emitters 116). The headphone device 100, either being a wired headphone or a wireless headphone, may operate in an aforementioned manner.

Moreover, although the present invention and its advantages have been described in detail, it should be understood that various changes, substitutions and alterations can be made herein without departing from the invention as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps

What is claimed is:

1. A wireless headphone device comprising:
a right side sound emitter and a left side sound emitter connected with extreme ends of a headphone band, wherein the right side sound emitter and the left side sound emitter are ear cups and the headphone band is made of a flexible material;
one or more auxiliary sound emitters present either adjacent to the extreme ends of the headphone band or on a right side of the right side sound emitter and a left side of the left side sound emitter, wherein the one or more auxiliary sound emitters are directed towards ears of the user;
a wireless control circuit for receiving audio data wirelessly from an audio device;
a power source for powering the wireless control circuit, the right side sound emitter, the left side sound emitter, and the one or more auxiliary sound emitters; and
audio control keys for controlling volumes of at least one of the right side sound emitter, the left side sound emitter, and the one or more auxiliary sound emitters.

2. The headphone device of claim 1, wherein the right side sound emitter and the left side sound emitter play different channels of the audio data.

3. The headphone device of claim 1, wherein the audio control keys are push buttons present on at least one of the right side sound emitter, the left side sound emitter, and the headphone band.

4. The headphone device of claim 1, wherein the audio control keys are soft keys present on at least one of the right side sound emitter, the left side sound emitter, and the headphone band.

5. The headphone device of claim 1, wherein the audio control keys are soft keys present on a user interface of the audio device.

6. The headphone device of claim 1, further comprising audio amplifiers for boosting volume of at least one of the right side sound emitter, the left side sound emitter, and the one or more auxiliary sound emitters.

7. The headphone device of claim 6, wherein the audio amplifiers are present on the user device.

8. The method of claim 1 wherein the one or more auxiliary sound emitters can be adjusted to provide an optimum listening experience to the user.

9. A wired headphone device comprising:
a right side sound emitter and a left side sound emitter connected with extreme ends of a headphone band, wherein the right side sound emitter and the left side sound emitter are ear cups and the headphone band is made of a flexible material;
one or more auxiliary sound emitters present either adjacent to the extreme ends of the headphone band or on a right side of the right side sound emitter and a left side of the left side sound emitter, wherein the one or more auxiliary sound emitters are directed towards ears of the user; and
a pair of wires connected to the right side sound emitter and the left side sound emitter, wherein the pair of wires transfer audio from an audio device to the right side sound emitter, the left side sound emitter, and the one or more auxiliary sound emitters.

10. The headphone device of claim 9, wherein the right side sound emitter and the left side sound emitter play different channels of the audio data.

11. The headphone device of claim 9, further comprising audio control keys for controlling volumes of at least one of the right side sound emitter, the left side sound emitter, and the one or more auxiliary sound emitters.

12. The headphone device of claim 11, wherein the audio control keys are push buttons present on at least one of the right side sound emitter, the left side sound emitter, and the headphone band.

13. The headphone device of claim 11, wherein the audio control keys are soft keys present on at least one of the right side sound emitter, the left side sound emitter, and the headphone band.

14. The headphone device of claim 11, wherein the audio control keys are soft keys present on a user interface of the audio device.

15. The headphone device of claim 9, further comprising audio amplifiers for boosting volume of at least one of the right side sound emitter, the left side sound emitter, and the one or more auxiliary sound emitters.

16. The headphone device of claim 9, wherein the audio amplifiers are present on the user device.

17. The method of claim 9, wherein the one or more auxiliary sound emitters can be adjusted to provide an optimum listening experience to the user.

18. A method of using a headphone device, the method comprising:
wearing a headphone by a user in either an overhead configuration, wherein during the overhead configuration a headphone band resides over head of the user and a right side sound emitter and a left side sound emitter of the headphone, present as ear cups, cover respective ears of the user; or
wearing the headphone by the user in around a neck configuration, wherein during around the neck configuration the headphone band lie around the neck of the user, the right side sound emitter and the left side sound emitter either partially cover ears of the user or lie exactly below the ears of the user, and one or more auxiliary sound emitters present on each of a right side and a left side of the headphone are directed towards respective ears of the user.

19. The method of claim 18, further comprising wirelessly receiving audio data from an audio device using a wireless control circuit.

20. The method of claim 18, further comprising receiving audio data from an audio device using a pair of wires connected to the right side sound emitter and the left side sound emitter.

21. The method of claim 18, further comprising playing different channels of audio data by the right side sound emitter and the left side sound emitter.

22. The method of claim 18, further comprising boosting volume of at least one of the right side sound emitter, the left side sound emitter, and the one or more auxiliary sound emitters using audio amplifiers.

23. The method of claim 18, wherein the one or more auxiliary sound emitters can be adjusted to provide an optimum listening experience to the user.
